(19) United States
(12) Patent Application Publication
(10) Pub. No.: US 2006/0228117 A1
(43) Pub. Date: Oct. 12, 2006

(54) Optical transmission device and optical transmission system

(75) Inventors: Sachiko Takeuchi, Yokohama-shi (JP); Susumu Kirii, Tokyo (JP); Kazuhiro Nojima, Yokohama-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi (JP)

(21) Appl. No.: 10/554,952

(22) PCT Filed: Jan. 14, 2005
(86) PCT No.: PCT/JP05/00366

§ 371 Date: Oct. 28, 2005

(30) Foreign Application Priority Data
Mar. 10, 2004 (JP) 2004-067017

(51) Int. Cl. H04B 10/04

(52) U.S. Cl. 398/183

(57) ABSTRACT

The subject of the present invention is to provide an optical transmitting device and an optical transmission system, capable of realizing an increase of multiple channels and an extension of a transmission distance at a low cost. In the present invention, the external modulation process is applied to a first optical signal (λ1), which is modulated by a transmission signal on a low frequency side for which low noise and distortion characteristics are required, out of the wideband frequency multiplexing electric signals by a first E/O converting unit (22). In contrast, the direct modulation process is applied to a second optical signal (λ2), which is modulated by a transmission signal on a high frequency side whose request for the transmission characteristic is not so high, by a second E/O converting unit (24) to execute an E/O conversion. As a result, an optical transmitting device and an optical transmission system, capable of realizing an increase of frequency range and multiple channels and an extension of a transmission distance can be manufactured at a low cost.

### TECHNICAL FIELD

The present invention relates to an optical transmitting device and an optical transmission system, which can be used in the optical communication, the optical CATV, and the like.

### BACKGROUND ART

In recent years, the CATV using the metal cable (e.g., coaxial cable) is spread. The multi-channel video signals in which various modulation-system signals are multiplexed are often transmitted from the CATV transmitting station as the transmission signal.

Meanwhile, various optical transmission systems utilizing the optical fiber are developed. For example, in the optical CATV, or the like, a broader band of a transmission frequency is demanded to implement an increase of multiple channels. Also, in such broader band situation, the sub-carrier multiplexing transmission system (referred to as the “SCM optical transmission system” hereinafter) is effective in putting the low loss characteristic and the wide band characteristic of the optical fiber to practical use.

According to this SCM optical transmission system, for example, the multi-channel video signal is frequency-multiplexed electrically by a plurality of sub-carriers each having a different frequency, then the frequency-multiplexed video signal is converted into the optical signal by applying the optical intensity modulation, and then the optical signal is transmitted via the optical fiber.

However, in this SCM optical transmission system, when the injection current to the laser is changed by the wideband frequency-multiplexed video signal to execute the electro-optic conversion (referred to as the “E/O conversion” hereinafter), i.e., the “direct modulation” is carried out, the wavelength chirp is generated to expand an oscillating wavelength of a laser, and thus the “intermodulation distortion” is generated by the influence of the non-linearity of the semiconductor laser (LD), the optical amplifier, the optical fiber transmission line, etc. In order to suppress this intermodulation distortion, limitations are imposed on multiplexing properties, i.e., the number of channels, the optical modulation index, and the transmission distance.

Therefore, the optical transmission system aiming at an improvement of this distortion characteristic has been proposed. As such optical transmission system, a following system is known (see Patent Literature 1, for example). That is, for example, the frequency-multiplexed electric signal is divided into a plurality of frequency bands. Then, in executing the E/O conversion by a plurality of semiconductor lasers (LDs), the electric signals in the divided bands are injected into the semiconductor lasers. In this manner, the optical signals are generated by the direct modulation. Then, the optical signals generated by the direct modulation every divided bandwidth and having different wavelength bands respectively are multiplexed into one optical signal, and then the signal is transmitted via the optical fiber.

However, according to the optical transmission system aiming at the above distortion improvement, since the E/O conversion is executed uniformly by the direct modulation process irrespective of the modulation system of the electric signal, a cost performance in the distortion improvement was not good in using a plurality of semiconductor lasers.

In contrast, as the modulation system different from this direct modulation process, the external modulation process is known. When the optical signal is modulated by this external modulation process, such optical signal is easily affected by the nonlinear light scattering in the optical fiber, e.g., SBS (stimulated Brillouin scattering) described in detail later, or the like. For this reason, the SBS suppress signal is often multiplexed and thus the frequency band is limited. Under such circumstances, the wideband frequency-multiplexed video signal is difficult to transmit.

The present invention has been made to overcome the problem in the prior art, and it is an object of the present invention to provide an optical transmitting device capable of realizing an increase of multiple channels and an extension of a transmission distance at a low cost.

Also, it is another object of the present invention to provide an optical transmission system capable of reducing a cost.

Patent Literature 1: JP-A-2002-164868

### DISCLOSURE OF THE INVENTION

First, the present invention provides an optical transmitting device for optically modulating optical signals by a frequency multiplexing electric signal to transmit, comprising:

a first E/O converting unit that executes an E/O conversion by an external modulation process to generate a first optical signal;

a second E/O converting unit that executes an E/O conversion by a direct modulation process to generate a second optical signal; and

a multiplexing unit that multiplexes the first optical signal and the second optical signal;

wherein the first E/O converting unit generates the first optical signal that is modulated by an electric signal on a low frequency side of the frequency multiplexing electric signal, and
wherein the second E/O converting unit generates the second optical signal that is modulated by an electric signal on a high frequency side of the frequency multiplexing electric signal.

The external modulation process is applied to the first optical signal, which is modulated by the transmission signal on the low frequency side for which the low noise characteristic and distortion characteristic are required, out of the wideband frequency multiplexing electric signals. Since the wavelength “chirping” (extension of the wavelength) is small when the optical modulation is executed by this external modulation process, degradation of various transmission characteristics due to the wavelength scattering, for example, the distortion degradation due to the scattering of the optical signal spectrum, or the like can be avoided.

In contrast, the direct modulation process is applied to the second optical signal, which is modulated by the transmission signal on the high frequency side whose request for the transmission characteristic is not so high, to execute the E/O conversion. Normally the direct modulation type E/O converter is inexpensive in contrast to the external modulation type E/O converter, and a reduction in cost can be achieved.

Also, in the present invention, second, a transmission signal on the low frequency side is a multi-channel AM signal and/or a QAM signal. A transmission signal on the high frequency side is a multi-channel FM signal and/or a PSK signal.

Accordingly, with regard to the transmission signal (first optical signal) in the UHFNHF band (described later) in which the terrestrial analogue/digital signals, etc. are multiplexed, the noise characteristic and the distortion characteristic can be maintained at a high level. In contrast, with regard to the transmission signal (second optical signal) on the high frequency band in which the BS broadcasting signal, etc. are multiplexed, the direct modulation can be employed because the required levels of the noise characteristic and the distortion characteristic are not so high. In this manner, the frequency band is divided in response to the required level of the noise characteristic and the distortion characteristic, then the optical modulation is applied to respective frequency bands by the different optical modulation system, and then the resultant signals are multiplexed after the optical modulation. As a result, while keeping the wideband not to narrow the frequency band, the good multi-channel optical transmission can be implemented via a single optical fiber.

Also, in the present invention, third, an optical output level of the first optical signal that is modulated by the multi-channel AM signal and/or the QAM signal on the low frequency side is higher than an optical output level of the second optical signal that is modulated by the multi-channel FM signal and/or the PSK signal on the high frequency side by a predetermined value or more, in response to transmission characteristics of an optical transmitting unit that transmits the optical signals to an optical receiving device.

According to this configuration, the optical level that is higher than the second optical signal, the request of the noise characteristic of which is not so high, by a predetermined value or more can be maintained with respect to the first optical signal whose request of the noise characteristic is high. Therefore, the predetermined CNR and in turn the good receiving characteristic can be maintained during the receiving operation.

Also, fourth, the present invention provided the optical transmitting device further comprises an optical amplifier that amplifies an optical signal after the multiplexing. An optical input level of the first optical signal is set higher than an optical input level of the second optical signal by a predetermined value or more upon inputting into the optical amplifier so that the optical output level of the first optical signal becomes higher than the optical output level of the second optical signal by a predetermined value or more upon outputting from the optical amplifier.

Normally, when the EDFA (Erbium Doped Fiber Amplifier) that can output the high power, described later, is used as the optical amplifier and then the two wavelengths optical signals having the optical level difference are input into this optical amplifier, such a peculiar phenomenon is generated that the level difference is reduced owing to the gain saturation of the optical amplifier.

Therefore, in the present invention, the level difference between two wavelengths is set higher by a level to estimate this peculiar phenomenon. Accordingly, since the optical signals having two wavelengths can be into the optical receiving unit to have the predetermined level difference, a predetermined CNR (Carrier to Noise Ratio) can be obtained even when the high power optical amplifier is used in the transmitting unit, and thus the good receiving characteristic can be maintained.

Also, in the present invention, fifth, an optical modulation index of the multi-channel FM signal and/or the PSK signal on the high frequency side is set to a particular value or more.

According to this configuration, the predetermined noise characteristic can be kept in the multi-channel FM signal on the high frequency side.

Also, in the present invention, sixth, a wavelength interval between the optical signals is set within a predetermined range.

For example, when the wavelength interval between the optical signals having two wavelengths is too narrow, the degradation of the transmission characteristics is brought about by the non-linearity effect peculiar to the optical fiber such as four wave mixing, cross phase modulation, or the like, described later. In contrast, when the wavelength interval is too wide, it is difficult to apply the good optical amplification to the optical signals having two wavelengths because of the wavelength dependency of the optical amplifier, or the like. Under such circumstance, in the present invention, generation of the above drawback is avoided by keeping the wavelength interval constant.

Seventh, the present invention provides an optical transmission system, comprising:

the optical transmitting device;

a single optical fiber for transmitting the first and second optical signals that are multiplexed by the multiplexing unit; and

an optical receiving unit including an O/E converting unit that receives collectively the first and second optical signals.

According to this configuration, the subscriber's home can receive the multi-channel video signal by a single O/E converting unit. Therefore, such signal can be received by the low-cost existing equipment correspondingly, and the optical transmission system capable of transmitting/receiving the multi-channel video signal over the wideband can be implemented at a low cost.

### BRIEF DESCRIPTION OF THE DRAWINGS

FIG. 1 is a configurative block diagram showing an optical transmission system according to a first embodiment of the present invention;

FIG. 2 is a configurative block diagram showing an optical transmitting device of the optical transmission system according to the first embodiment of the present invention;

FIG. 3 is a configurative block diagram showing an optical receiving unit of the same optical transmission system;

FIG. 4 is a graph showing a relationship between wavelength of first and second optical signals and an optical intensity used in the first embodiment of the present invention;

FIG. 5 is a graph showing an optical level difference dependency of CNR in the first optical signal in the first embodiment;

FIG. 6 is a graph showing an optical modulation index dependency of CNR in the second optical signal in the first embodiment;

FIG. 7 is a configurative block diagram showing an optical transmission system according to a second embodiment of the present invention;

FIG. 8 is a graph showing an optical level difference dependency of CNR in the first optical signal in the second embodiment; and

FIG. 9 is a graph showing a correlation between a gain and a wavelength in EDFA in the second embodiment.

### DESCRIPTION OF REFERENCE NUMERALS AND SIGNS

2 denotes an (frequency multiplexing) optical transmitting device, 20A to 20D denote first to fourth signal outputting units (signal source), 20A denotes a terrestrial analogue signal (AM signal), 20B denotes a terrestrial digital signal (QAM signal), 20C denotes a CATV broadcasting signal (AM and/or QAM signal), 20D denotes a BS signal (FM signal), 21 denotes an electric signal multiplexing unit, 22 denotes a first E/O converter portion, 24 denotes a second E/O converter portion, 25 denotes an attenuator portion, 26 denotes a multiplexer portion, 3 denotes an optical transmitting unit (optical fiber), 4 denotes a branching unit, 5 denotes an (frequency multiplexing) optical receiving unit, 51 denotes an O/E converter portion, 52 denotes an amplifier portion, 54 denotes a tuner and television set, 6, 6A, 6B denote an optical amplifier, P1 denotes a first optical signal (intensity), P2 denotes a second optical signal (intensity), λ1 denotes a first wavelength (1.555 μm), λ2 denotes a second wavelength (1.560 μm).

### BEST MODE FOR CARRYING OUT THE INVENTION

Embodiments of the present invention will be explained in detail with reference to the accompanying drawings hereinafter.

### First Embodiment

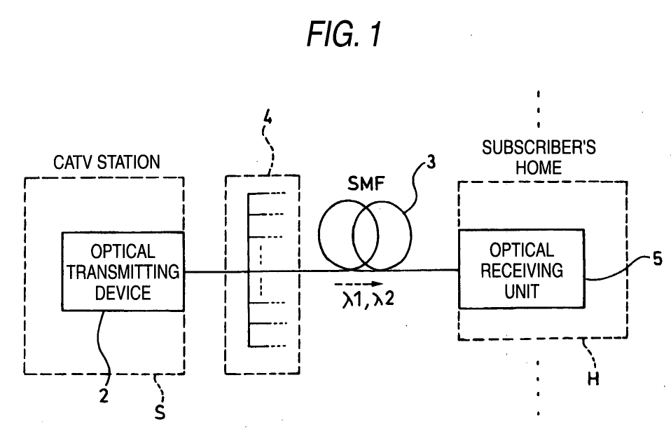

FIG. 1 shows an optical transmission system according to a first embodiment of the present invention. This optical transmission system constitutes a optical CATV network system, and includes an optical transmitting device 2, an optical transmitting unit 3, a branching unit 4, and an optical receiving unit 5.

Normally, when the transmission signal is optically modulated by the optical transmitting device, the external modulation process by which no scattering is generated in theory and which is excellent in the noise and the distortion characteristic is preferable. However, the external modulation process is readily affected by the nonlinear effect such as SBS, or the like, and the limitation is imposed on the frequency band by the signal superposed to suppress such effect.

For this reason, in the present invention in which the transmission signal whose frequency band is broadened particularly, etc. are used, the transmission signal on the high frequency side (the FM signal, or the like) is not superposed on the E/O converter in the external modulation process but modulated optically by the E/O converter provided separately in the direct modulation process because the transmission characteristic required for such signal is low. In other words, in the present invention, the transmission signal is divided into two bands in response to the frequency range and the required characteristics, then two E/O converter portions are provided such that the transmission signal on the low frequency side is modulated optically by the external modulation and the transmission signal on the high frequency side is modulated optically by the direct modulation, and then these optically modulated optical signals are multiplexed.

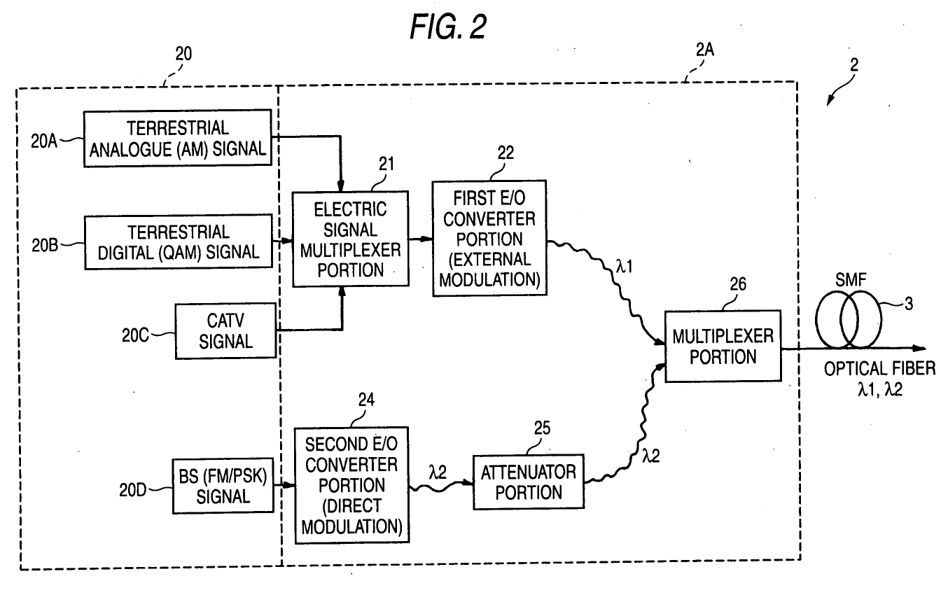

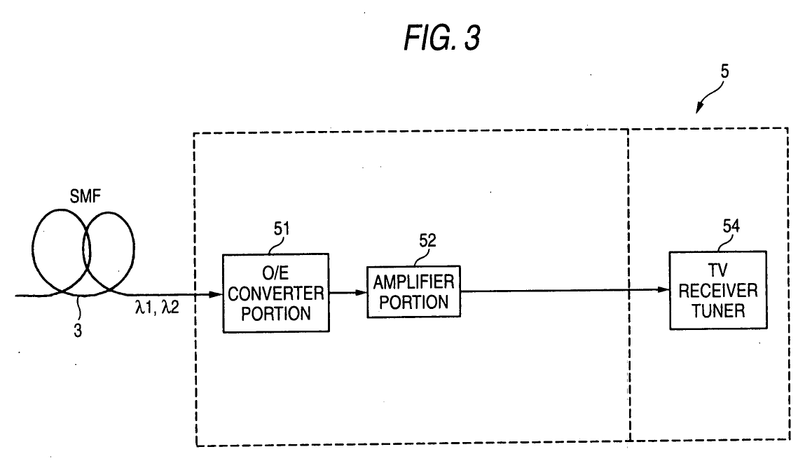

Therefore, the optical transmitting device 2 shown in FIG. 2 is constructed by providing first to fourth signal outputting units 20A to 20D as signal sources, an electric signal multiplexing unit 21 for multiplexing first to third electric signals, a first E/O converter portion 22 based on the external modulation process, a second E/O converter portion 24 based on the direct modulation process, an attenuator portion 25, and a multiplexer portion 26 to the broadcasting station S. Then, this optical transmitting device 2 transmits optically the optical signal having two wavelengths (λ1, λ2), whose wavelength bands modulated by the frequency multiplexing video signal respectively are in the 1.5 μm band, as the optical frequency multiplexing signal from the broadcasting station S side to each subscriber's home H side via the single optical fiber 3 described later.

The terrestrial analogue AM signal, the terrestrial digital QAM signal, and the CATV signal, i.e., the AM and/or QAM signal sent out from the first to third signal outputting units 20A to 20C as the transmission signal on the low frequency side (frequency multiplexing video signal) are multiplexed into one signal by the electric signal multiplexing unit 21, and then input into the first E/O converter portion 22 and converted into a first optical signal having a first wavelength λ1.

In other words, in the present embodiment, the transmission signal on the low frequency side (frequency multiplexing video signal) such as the AM signal like the terrestrial analogue signal or the like, the QAM (Quadrature Amplitude Modulation; composite modulation system of the phase modulation and the amplitude modulation) signal like the terrestrial digital signal or the like, and the CATV signal or the like are output from the first to third signal outputting units 20A to 20C to the electric signal multiplexing unit 21 respectively. Therefore, respective outputs of the first to third signal outputting units 20A to 20C are connected to the input of the electric signal multiplexing unit 21.

Also, the frequency multiplexing video signal derived by multiplexing the electric signals on the low frequency side output from the electric signal multiplexing unit 21 is output to the first E/O converter portion 22 in the external modulation process. Therefore, the output of the electric signal multiplexing unit 21 is connected to the input of the first E/O converter portion 22.

In contrast, the transmission signal on the high frequency side (frequency multiplexing video signal) is output from the fourth signal outputting unit 20D to the second E/O converter portion 24. This frequency multiplexing video signal on the high frequency side is the FM signal such as the satellite broadcasting (BS) signal or the PSK signal, for example, and is converted into the second optical signal having a second wavelength λ2 by the second E/O converter portion 24 in the direct modulation process.

In the first E/O converter portion 22 in the external modulation process, the light from the light source is externally modulated by using the multi-channel AM/QAM electric signal multiplexed into one signal on the low frequency side, and the light (first optical signal) having the first wavelength λ1 (=1.555 μm) is emitted as the optical output P1. In the present embodiment, for example, the semiconductor laser (LD) as the light source and the external modulator (e.g., the LN modulator, the EA modulator, or the like), both although not shown, are provided to the first E/O converter portion 22.

In the present embodiment, the distributed feedback semiconductor laser (DFB-LD) that is suitable for the large-capacity long-haul communication because of the stable oscillation in a single mode is employed as the semiconductor laser (LD) which serves as the light source.

Also, the Mach-Zehnder external modulator utilizing the electro-optic effect (concretely, the Pockels effect), in which the refractive index is changed when the voltage is applied, is employed as the LN modulator. The good optical intensity modulation without the “chirping” can be executed at a high speed over the very wideband. This Mach-Zehnder external modulator is excellent in the intermodulation distribution characteristic because the wavelength chirp is not generated in theory in the modulation, unlike the direct modulation process. Also, this Mach-Zehnder external modulator has such a feature that the compensation of the waveform distortion caused because the input/output characteristic of the modulator is sinusoidal is easily executed because the input/output characteristic can be expressed by a simple formula.

Here, the “chirping” signifies such a phenomenon that, when the direct modulation is executed by changing the injection current into the semiconductor laser, a change of the refractive index occurs in its inside and as a result the wavelength is changed. When this chirping occurs, the waveform spectrum is expanded, so that the optical communication is affected by the wavelength scattering of the long-haul fiber and a limitation of the transmission distance is brought about.

The EA modulator utilizes the electro-absorption effect of the semiconductor. The energy level difference (band gap) is changed between the conduction band and the valence band by applying the electric field to the n type and p type layers between which the waveguide layer having the multiple quantum well structure is put. Then, a quantity of absorbed photon is changed, and thus the optical intensity modulation is executed. The downsizing can be attained, and also the optical intensity modulation can be realized at a low voltage.

The second E/O converter portion 24 generates the light (second optical signal) having the second wavelength λ2 (=1.560 μm), and the semiconductor laser (LD) is employed. Also, when the injection current into the laser is modulated by the frequency-multiplexed electric signal on the high frequency side (frequency multiplexing video signal) such as the satellite broadcasting (BS) signal, or the like, the optical intensity modulation is executed in the second E/O converter portion 24. The second optical signal is emitted as the second optical signal P2.

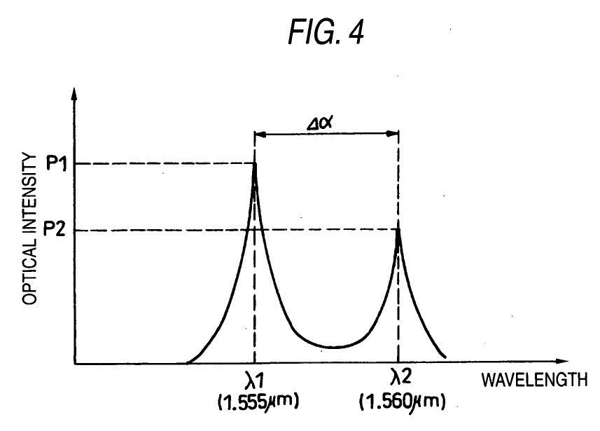

Here, a wavelength interval between the first and second optical signals (as shown in FIG. 4, a wavelength interval Δα between two optical signals) is adjusted in a predetermined constant range (e.g., 5 nm in the present embodiment).

As described above, when the light is modulated by the external modulation process, the light modulation is readily influenced by the “SBS (stimulated Brillouin scattering)” described later because a width of the optical wavelength spectrum is narrow. Thus, the signal for suppressing SBS must be multiplexed. However, in the present embodiment, only the low frequency band (almost 70 to 770 MHz) containing the terrestrial analogue and digital signals in the UHFNHF band, in which the optical output P1 having the first wavelength is generated, is employed as the frequency band in which the light is modulated by the external modulation process, and the high frequency band (almost 1000 to 1350 MHz) containing the satellite broadcasting (BS) signal is excluded. It is considered that the frequency out of the low frequency band is effective as the frequency of the SBS suppressing signal, and there is no need to execute the down converting that narrows the band, or the like when only the low frequency band is transmitted.

Here, the SBS (stimulated Brillion scattering) is such a phenomenon that a reflected light with a wavelength that is slightly shifted from an input wavelength is generated when a strong optical power that is in excess of a predetermined quantity of light is input into the optical fiber, and means the scattering caused by the acoustic phonon.

In the attenuator portion 25, the degradation of the noise characteristic of the optical signal with the wavelength λ1 due to the optical signal with the wavelength λ2 is suppressed by providing a level difference at a predetermined value or more between the optical output intensities of the first and second optical signals (which will be described in detail later), so that the noise characteristic of two waves (that is, the first and second optical signals (λ1, λ2)) in an O/E converter portion 51, described later, of the optical receiving unit 5 after the O/E conversion can be ensured without fail. An attenuator, or the like is used.

The multiplexer portion 26 multiplexes/couples two waves of the first and second optical signals (λ1, λ2). An optical coupler, e.g., an optical fiber coupler (for example, a planar waveguide type optical coupler, or the like may be employed in addition to this) is used. The first and second optical signals (λ1, λ2) multiplexed by this multiplexer portion 26 are transmitted collectively to each subscriber's home, in which the optical receiving unit 5 is provided, via one optical fiber as the optical transmitting unit 3.

The optical transmitting unit 3 constitutes a part of the FTTH (Fiber To The Home) optical CATV network using the SMF (Single Mode Fiber) optical fiber. One end thereof is connected optically to one end portion of the multiplexer portion 26, and the other end is connected to the O/E converter portion 51, described later, of the optical receiving unit 5.

Here, the optical CATV network of the present invention is not limited to FTTH. The optical fiber is connected to the building in which the office, or the like is located, and the FTTB (Fiber To The Building) using the metal cable may be employed as the leading wire extended therefrom. Otherwise, the optical fiber is provided just before the home, and the FTTC (Fiber To The Curb) using the metal cable, or the like may be employed to bring the cable into the home.

The branching unit 4 branches the optical signal to the subscriber's home to which the optical signal is transmitted, and the optical coupler (optical branching unit) is used. More particularly, various types such as optical fiber coupler type, the planar waveguide type, and the like can be applied.

The optical receiving unit 5 has the O/E converter portion 51, an amplifier portion 52, etc. in the optical subscriber's line terminating set (ONU; Optical Network Unit), and has a tuner and television set 54, etc.

Out of them, the O/E converter portion 51 receives collectively the optical signals having the first wavelength λ1 and the second wavelength λ2 transmitted through the optical fiber as the optical transmitting unit 3 and sent out therefrom, and then applies the O/E conversion to them. That is, the O/E converter portion 51 converts two-wave optical signals, which are output from the signal source and multiplexed as the frequency multiplexing video signals in respective channels, into the frequency multiplexing electric (video) signals, which correspond to the terrestrial analogue AM signal, the terrestrial digital QAM signal, the CATV signal, the satellite broadcasting (BS) signal, and the like respectively. Then, these electric signals are output to the amplifier portion 52.

In the case of the present embodiment, for example, a PIN photodiode is used particularly as a light receiving element in the O/E converter portion 51. But an APD photodiode whose sensitivity is enhanced rather than this PIN photodiode may be used.

In the present embodiment, the optical signal in the overall band is received collectively by one light receiving element as the O/E converter portion 51. Therefore, the present embodiment is constructed such that a desired signal can be extracted by the publicly known means.

The tuner and television set 54 is connected to the optical subscriber's line terminating set (ONU) via the coaxial cable, or the like, without the intervention of STB (Set Top Box), or the like.

Next, setting conditions of respective elements (parameters) in the optical transmission system using the optical transmitting device 2 and the optical receiving unit 5 in the present embodiment will be explained concretely hereunder.

(I) In order to assure the enough transmission quality, the optical transmission system of the present invention is constructed such that at least the optical output intensity P1 [dB] from the first E/O converter portion 22 is greater than the optical output intensity P2 [dB] from the second E/O converter portion 24.

(I-A) More particularly, it is the satellite broadcasting (BS) signal, or the like, i.e., the FM signal and/or the PSK signal on the high frequency side that is subjected to the E/O conversion by the second E/O converter portion 24. The noise characteristic required for the FM signal and/or the PSK signal is essentially low. Therefore, the present embodiment is constructed such that a desired level difference can be kept by lowing a level of the optical output intensity P2 [dB] of the second E/O converter portion 24. Thus, the noise characteristic of the electric signal after the E/O conversion of two waves in the optical receiving unit 5 can be kept without fail.

Particularly, in the present embodiment, for example, the level difference between the optical outputs from the first and second E/O converter portions 22, 24 is set to satisfy a following inequality.
P1-P2>6.5 [dB] (1)

where P1: output of the first E/O converter portion 22, and

P2: output of the second E/O converter portion 24.

(I-B)

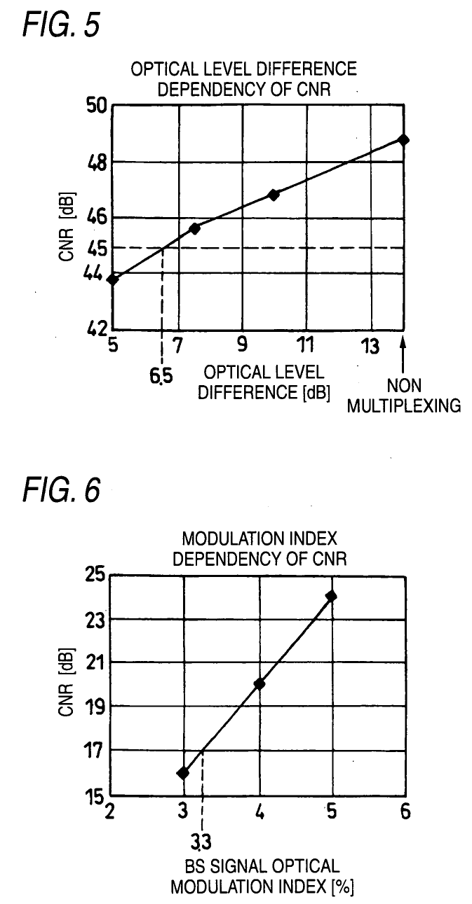

The ground of this relation will be discussed hereunder. First, a correlation between an optical level difference between two waves and CNR (Carrier to Noise Ratio) in the receiving operation is examined by using the optical transmission system of the present embodiment. Then, a relationship shown in FIG. 5 was obtained by measuring these elements.

According to a graph shown in FIG. 5 indicating the optical level difference dependency of CNR, it is understood that the CNR can be improved as the level difference is increased.

For example, the finding indicating that 45 [dB] is needed as the CNR in the case of the present embodiment was obtained. Therefore, it is appreciated that, as given in the above inequality (1), the level difference in excess of 6.5 [dB] must be applied between the optical output intensities P1, P2 of two waves output from the first and second E/O converter portions 22, 24 to ensure 45 [dB].

(II) In contrast, in order to keep the enough transmission quality while suppressing the noise characteristic below a desired level, the method of improving the CNR by increasing the optical modulation index in this high frequency band is effective for the optical signal in the high frequency band, i.e., the second optical signal.

That is, in order to examine the correlation between the optical modulation index and the CNR, these elements were measured. Then, a relationship shown in FIG. 6 was derived. According to a graph in FIG. 6 showing an optical modulation index dependency of CNR, it is understood that the CNR can be improved as the modulation factor is enhanced.

For example, it is understood that, in order to ensure 17 [dB] as the CNR in the high frequency band, for example, the modulation factor of more than 3.3 [%] is needed in the optical direct modulation in the second E/O converter portion 24, i.e.,
M2>0.033 (2)

where M2: optical direct modulation factor in the second E/O converter portion 24.

(III) In addition, when the optical intensity is increased excessively, such a phenomenon is brought about that the polarization is induced by the electric field of light and exerts an influence on the refractive index is not proportional to a magnitude of the electric field (the linearity is lost). That is, the so-called non-linearity is generated. Therefore, the countermeasure against this is required.

For example, in order to prevent the degradation of the noise characteristic and the distortion characteristic due to the non-linearity effect such as four wave mixing in which two lights or more act mutually to generate a new light, cross phase modulation in which a phase is changed by the intensity of other light, etc., a wavelength interval (Δα) exceeding a predetermined range is needed.

In the measurement of the CNR, etc. at this time, for example, the optimum wavelength interval (Δα) is set to satisfy a following equation.
Δα≈5 [nm]tm (3)

### Second Embodiment

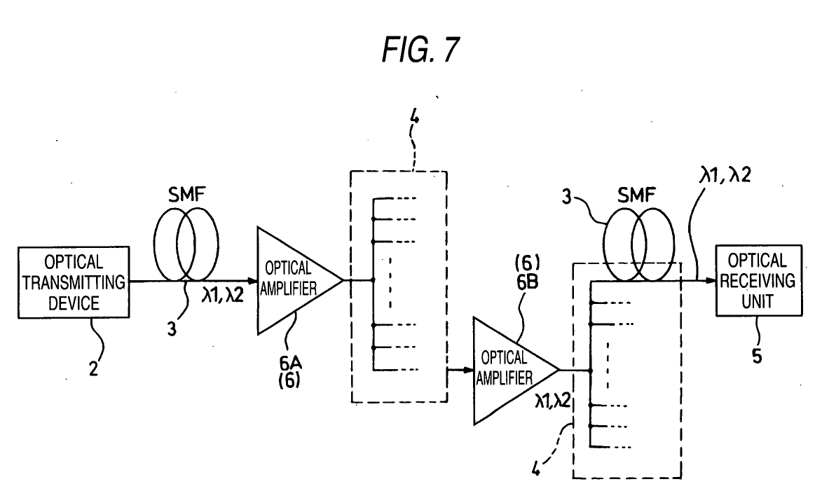

Next, an optical transmission system according to a second embodiment of the present invention will be explained with reference to FIG. 7 to FIG. 9 hereunder. Here, in the present embodiment, the same reference symbols are affixed to the same portions as those in the first embodiment to avoid their duplicated explanations.

A difference of an optical transmission system according to a second embodiment from the first embodiment is that, as shown in FIG. 7, the optical amplifier 6 is provide in a multi-stage fashion (in the present embodiment, optical amplifiers 6A, 6B in two stages) to distribute (or transmit over a long distance) the multi-channel signal (frequency multiplexing video signal) in response to a large number of subscribers. Accordingly, the present embodiment is constructed such that outputs of the first and second optical signals λ1, λ2 are increased.

The optical amplifier 6 amplifies optically the first and second optical signals λ1, λ2 of two waves in response to the transmission characteristic of the optical transmitting unit (optical fiber) 3 that transmits the signals to the optical receiving unit such that an optical level of the first optical signal (wavelength λ1) is set higher than that of the second optical signal (wavelength λ2) by a predetermined value.

In the case of the present embodiment, the erbium doped fiber amplifier (EDFA) using the erbium doped optical fiber, which has the transition corresponding to the 1.55 μm band, and the semiconductor laser in combination is employed. This amplifier is excellent in the high output,.the low noise characteristic, the wideband, and the like.

Here, this optical amplifier is not particularly limited to this erbium doped fiber amplifier (EDFA). Various types such as the fiber Raman amplifier (FRA), the semiconductor optical amplifier (SOA), and the like, for example, may be applied in addition to the above.

Next, setting conditions of respective elements (parameters) in the optical transmission system using the optical transmitting device 2 and the optical receiving unit 5 in the present embodiment will be explained concretely hereunder.

In the optical transmission system of the present embodiment, similar conditions to those in (I) to (III) explained in the first embodiment are imposed.

These conditions will be explained hereunder.

(I) In order to assure the sufficient transmission quality, like the first embodiment, the present embodiment is constructed such that at least the optical output intensity P1 [dB] of the first E/O converter portion 22 is larger than the optical output intensity P2 [dB] of the second E/O converter portion 24.

In particular, in the present embodiment, for example, the optical intensity_level difference of two waves being output from the first and second E/O converter portions 22, 24 (see FIG. 2) is set to satisfy a following inequality.
P1-P2>10.5 [dB] (4)

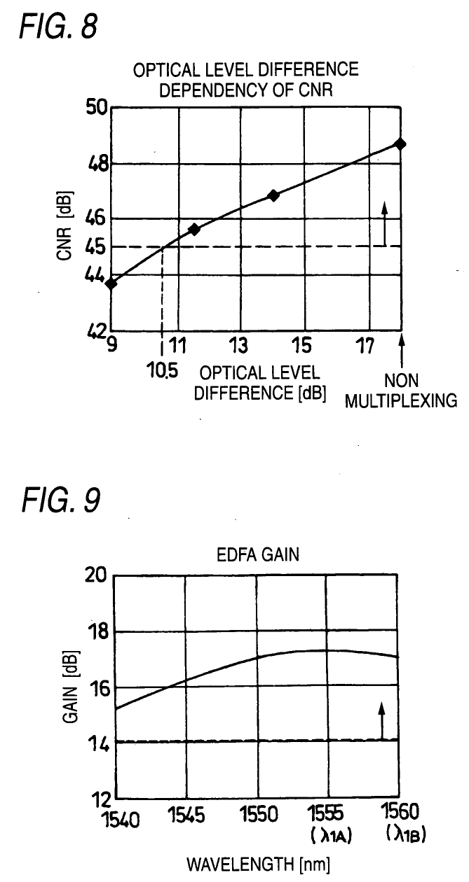

More particularly, in the present embodiment, in order to examine a correlation between the optical level difference between two waves and the CNR (Carrier to Noise Ratio) in the receiving operation, these elements were measured by using the optical transmission system. Then, a relationship shown in FIG. 8 was derived.

Also, from a graph in FIG. 8 showing an optical level difference dependency of CNR, it is understood that the CNR can be improved as the level difference is increased.

For example, in order to ensure 45 [dB] as the CNR, as given by the inequality (4), a difference of 10.5 [dB] or more must be applied between the optical output intensities P1, P2 of the first and second E/O converter portions 22, 24.

In this manner, the required level difference between the optical 25 outputs from the first and second E/O converter portions 22, 24 (see FIG. 2) to isolate two waves is different from the case of the first embodiment. The reason for this will be given as follows.

That is, in the present embodiment, in the case where the optical amplifier 6 is used at the high output in its saturation state, such a peculiar phenomenon is generated that the optical level difference between two wavelengths (λ1, λ2)is shortened when the lights having two wavelengths (λ1, λ2) having a certain optical level difference are input into this optical amplifier 6.

For example, when the lights having two wavelengths (λ1, λ2) having a predetermined optical level difference are input, such a peculiar phenomenon is generated that the optical level difference is shortened by almost 2 to 3 dB per stage of the optical amplifier 6. Therefore, the level difference corresponding to the number of stages provided in the optical amplifier must be ensured to estimate previously such generation of this phenomenon. For instance, since the two-stage optical amplifier is used in the present embodiment, the optical level difference is increased rather than the value 6.5 [dB] in the inequality (1) by at least almost 4 [dB], and thus the optical level difference is set to 10.5 [dB] to ensure 45 [dB] of the CNR.

As a result, the high-power optical amplifier can also be used.

Next, the countermeasure against the non-linearity phenomenon generated when the optical intensity is excessively increased must be taken. Therefore, in order to prevent the degradation of the noise characteristic and the distortion characteristic due to the non-linearity effect, the wavelength interval (Δα) must be set within a predetermined range.

More particularly, in case the EDFA (Erbium Doped Fiber Amplifier is used as the optical amplifier 6, the wavelength interval must be set smaller than a predetermined value to get a stable amplification factor, e.g., a gain to the wavelength, as shown in a graph of FIG. 9. Therefore, in the present embodiment, the wavelength interval is set to 5 nm, for example.

In the present invention, the optical signal is transmitted by the pass-through system (the signal is transmitted at the same frequency as the received broadcasting (radio wave) signal not to change the modulation frequency) without the frequency conversion (the broadcasting signal peculiar to the CATV, the BS broadcasting signal, or the like is frequency-converted into the signal in the UHF band or the VHF band and then transmitted). Therefore, the multi-channel video signal can be received conveniently by the low-cost existing equipment at the subscriber's home respectively.

The present invention is explained in detail with reference to particular embodiments. But it is apparent for the person skilled in the art that various variations and modifications can be applied without departing from a spirit and a scope of the present invention.

This application is based upon Japanese Patent Application (Application No. 2004-067017) filed on Mar. 10, 2004, and the contents thereof are incorporated herein by reference.

### INDUSTRIAL APPLICABILITY

According to the present invention, the external modulation process is applied to the first optical signal, which is modulated by the transmission signal on the low frequency side for which the low noise characteristic and distortion characteristic are required, out of the wideband frequency multiplexing electric signals. Since the wavelength “chirping” (extension of the wavelength) is small when the optical modulation is executed by this external modulation process, degradation of various transmission characteristics due to the wavelength scattering, for example, the distortion degradation due to the scattering of the optical signal spectrum, or the like can be avoided. In contrast, the direct modulation process is applied to the second optical signal, which is modulated by the transmission signal on the high frequency side whose request for the transmission characteristic is not so high, to execute the E/O conversion. Normally the direct modulation type E/O converter is inexpensive in contrast to the external modulation type E/O converter, and a reduction in cost can be achieved. As a result, an increase of multiple channels and an extension of a transmission distance can be realized, and also a cost reduction of the optical receiving unit and the optical transmission system can be attained, so that the present invention is useful for the optical transmission system for the optical communication such as the optical communication, the optical CATV, and others.

1. An optical transmitting device for optically modulating optical signals by a frequency multiplexing electric signal to transmit, comprising:
a first E/O converting unit that executes an E/O conversion by an external modulation process to generate a first optical signal;
a second E/O converting unit that executes an E/O conversion by a direct modulation process to generate a second optical signal; and
a multiplexing unit that multiplexes the first optical signal and the second optical signal;
wherein the first E/O converting unit generates the first optical signal that is modulated by an electric signal on a low frequency side of the frequency multiplexing electric signal, and
wherein the second E/O converting unit generates the second optical signal that is modulated by an electric signal on a high frequency side of the frequency multiplexing electric signal.

2. The optical transmitting device according to claim 1, wherein a transmission signal on the low frequency side is a multi-channel AM signal and/or a QAM signal, and
wherein a transmission signal on the high frequency side is a multi-channel FM signal and/or a PSK signal.

3. The optical transmitting device according to claim 1, wherein an optical output level of the first optical signal that is modulated by the multi-channel AM signal and/or the QAM signal on the low frequency side is higher than an optical output level of the second optical signal that is modulated by the multi-channel FM signal and/or the PSK signal on the high frequency side by a predetermined value or more, in response to transmission characteristics of an optical transmitting unit that transmits the optical signals to an optical receiving device.

4. The optical transmitting device according to claim 1, further comprising:
an optical amplifier that amplifies an optical signal after the multiplexing;
wherein an optical input level of the first optical signal is set higher than an optical input level of the second optical signal by a predetermined value or more upon inputting into the optical amplifier so that an optical output level of the first optical signal becomes higher than an optical output level of the second optical signal by a predetermined value or more upon outputting from the optical amplifier.

5. The optical transmitting device according to claim 2, wherein an optical modulation index of the multi-channel FM signal and/or the PSK signal on the high frequency side is set to a particular value or more.

6. The optical transmitting device according to claim 1, wherein a wavelength interval between the optical signals is set within a predetermined range.

7. An optical transmission system, comprising:
the optical transmitting device set forth in claim 1;
a single optical fiber for transmitting the first and second optical signals that are multiplexed by the multiplexing unit set forth in claim 1; and
an optical receiving unit including an O/E converting unit that receives collectively the first and second optical signals set forth in any one of claims 1 to 6.

8. The optical transmitting device according to claim 3, wherein an optical modulation index of the multi-channel FM signal and/or the PSK signal on the high frequency side is set to a particular value or more.

9. The optical transmitting device according to claim 4, wherein an optical modulation index of the multi-channel FM signal and/or the PSK signal on the high frequency side is set to a particular value or more.
